(19) United States
(12) Patent Application Publication
(10) Pub. No.: US 2024/0193226 A1
(43) Pub. Date: Jun. 13, 2024

(54) METHOD AND ELECTRONIC DEVICE FOR PERFORMING ROBUST LOW-RANK MATRIX RECOVERY VIA HYBRID ORDINARY-WELSCH FUNCTION

(71) Applicant: City University of Hong Kong, Hong Kong (HK)

(72) Inventors: Zhiyong WANG, Hong Kong (HK); Hing Cheung SO, Hong Kong (HK); Abdelhak M. ZOUBIR, Darmstadt (DE)

(21) Appl. No.: 18/070,429

(22) Filed: Nov. 28, 2022

(51) Int. Cl. G06F 17/16

(52) U.S. Cl. CPC G06F 17/16

(57) ABSTRACT

A method for performing a robust low-rank matrix recovery using Hybrid Ordinary-Welsch Function is provided. The method includes: receiving object data, wherein the object data comprises an incomplete matrix; identifying a plurality of first values and a plurality of first indexes of a plurality of first entries of the incomplete matrix, and one or more second values and one or more second indexes of one or more second entries of the incomplete matrix according to the object data; inputting the first values (X₁₀₆ ), the first indexes(Ω), a rank r, the second indexes, a preset first parameter (ξ₁), a preset second parameter (ζ₂), a first maximum iteration number (I₁), a second maximum iteration number (ζ₂), a first tolerance parameter (ζ₁) and a second tolerance parameter (ζ₂) into an executed analysis model using HOW algorithm; and obtaining a recovered complete matrix corresponding to the incomplete matrix from the analysis model.

### FIELD OF THE INVENTION

The present invention generally relates to data recovery, and in particular, to a method and electronic device for performing robust low-rank matrix recovery by an analysis model using Hybrid Ordinary-Welsch (HOW) Function.

### BACKGROUND OF THE INVENTION

Low-rank matrix recovery (LRMR) refers to seeking the potential low-dimensional structure from a degraded matrix with possibly missing and/or noisy entries, and has been widely used in numerous real-life applications such as image restoration, hyper-spectral remote sensing, shadow removal and video separation. There are two main strategies to achieve LRMR, namely, rank minimization and factorization-based low-rank approximation. The former performs restoration via imposing rank constraint on the recovered matrix. However, direct rank minimization is NP-hard since the rank is discrete and nonconvex. To alleviate this problem, nuclear norm minimization is exploited, which is the tightest convex relaxation of rank minimization. In addition, many algorithms, including singular value thresholding (SVT), fixed point continuation with approximating singular value decomposition (FPCA), and accelerated proximal gradient with linesearch (APGL), have been developed, but they require full singular value decomposition (SVD) at each iteration, which is computationally demanding, particularly for large-scale problems.

To avoid SVD, low-rank matrix factorization methods corresponding to the second strategy, have been proposed, whose idea is to utilize the product of two much smaller matrices to model the degraded matrix so that the low-rank property is automatically fulfilled. Although the optimization problem based on factorization is nonconvex, empirical results demonstrate that its low-rank solution can be as reliable as those obtained by solving the convex nuclear norm minimization. Actually, recent theoretical studies have shown that the factorization-based LRMR has no spurious local minima and fulfills the strict saddle property which requires the cost function to have a directional negative curvature at all critical points but local minima. In other words, this means that global optimality can be achieved.

While the derivation of the forementioned schemes is based on the [symbol] ₂-norm, which is only optimal for Gaussian noise, non-Gaussian gross errors occur in many practical scenarios. A commonly-used strategy to combat outliers is to utilize the [symbol] ₁-norm, resulting in many optimization methods such as robust matrix factorization by majorization minimization (RMF-MM), practical low-rank matrix approximation via robust [symbol] ₁-norm (RegL₁) and semisoft go decomposition (SSGoDec). However, the [symbol] ₁-norm has a bias problem and is still vulnerable to large gross errors. Moreover, if the current model is very sparse, the sparse regularizer using the [symbol] ₁-norm can overestimate the number of non-zero coefficients. Thus, employing a nonconvex function for LRMR when the observed data are contaminated by big sparse outliers, such as the nonconvex regularization principal component analysis (NCRPCA) [4], has been recently suggested. Furthermore, nonconvex [symbol] ₚ-norm minimization with p<1 can be efficiently solved with closed-form solutions for two special cases, namely, p=½ and p=⅔, resulting in (S+L)_{1/2} and (S+L)_{2/3}, respectively, for robust LRMR.

On the other hand, correntropy with Gaussian kernel as the nonconvex error measure has achieved considerable success in robust matrix completion (RMC) and robust principal component analysis (RPCA), and a representative algorithm is half-quadratic alternating steepest descent (HQ-ASD). The relationship between the correntropy and Welsch M-estimator is that maximizing correntropy equals minimizing the Welsch M-estimator cost function. However, the correntropy/Welsch function down-weighs all data including those ‘normal’ values (i.e., observations without noise or with only Gaussian noise), and its implicit regularizer (IR) cannot achieve sparseness.

In other words, to resist outliers, the correntropy criterion or Welsch function has been exploited for low-rank matrix recovery. However, it down-weighs all observations including the uncontaminated data. On the other hand, its implicit regularizer (IR) cannot achieve sparseness, and the sparseness is a desirable property in many practical scenarios.

Therefore, there is a need for performing matrix recovery without down-weighing uncontaminated data or losing sparseness, so to improve the efficiency and performance of matrix recovery in applications, such as image restoration, hyper-spectral remote sensing, shadow removal and video separation.

### SUMMARY OF THE INVENTION

Thus, a new robust M-estimator called hybrid ordinary-Welsch (HOW) function is proposed in the presented disclosure. In spite of the nonconvexity, the Legendre-Fenchel transform is used to convert the HOW into a sum of two convex functions via enlarging the parameter space, yielding a tractable problem. Moreover, the implicit regularizer (IR) corresponding to the HOW can attain sparseness and its proximity operator is derived. Unlike the biasedness of the [symbol] ₁-norm, the provided method is unbiased. The HOW is then exploited for robust matrix completion and robust principal component analysis, and an efficient algorithm is developed as their solver.

A computer-implemented method for performing a robust low-rank matrix recovery using Hybrid Ordinary-Welsch (HOW) Function by an electronic device is provided. The method includes: receiving, by a processor of the electronic device, object data, wherein the object data comprises an incomplete matrix, wherein the incomplete matrix is a low-rank matrix; identifying, by the processor, a plurality of first values and a plurality of first indexes of a plurality of first entries of the incomplete matrix, and one or more second values and one or more second indexes of one or more second entries of the incomplete matrix according to the object data, wherein the first values of the first entries are determined as original values of the first entries, and the one or more second values of the second entries are determined as non-original values of the second entries; inputting, by the processor, the first values (X_{Ω}), the first indexes(Ω), a rank r, the second indexes, a preset first parameter (€₁), a preset second parameter (ξ₂), a first maximum iteration number (I₁), a second maximum iteration number (I₂), a first tolerance parameter (ζ₁) and a second tolerance parameter (ζ₂) into an executed analysis model using HOW algorithm; and obtaining, by the processor, a recovered complete matrix corresponding to the incomplete matrix from the analysis model, so as to obtain optimized one or more second values of the second entries, wherein the optimized one or more second values are determined as original values of the second entries, such that missing data corresponding to the second entries of the incomplete matrix is recovered by the recovered complete matrix.

In accordance to another aspect of the present invention, an electronic device is provided, and the electronic device comprises a processor configured to execute machine instructions to implement the method described above.

### BRIEF DESCRIPTION OF THE DRAWINGS

Embodiments of the invention are described in more details hereinafter

with reference to the drawings, in which:

FIG. 1 depicts a block diagram illustrating an electronic device in accordance with one embodiment of the present invention;

FIG. 2 depicts a schematic diagram illustrating data recovery operation performed by the analysis model;

FIG. 3 depicts a flowchart of a robust low-rank matrix recovery using Hybrid Ordinary-Welsch (HOW) Function by the electronic device;

FIG. 4A depicts a plot of p_{φ}(y) for different regularizers;

FIG. 4B depicts a plot of numerical curves of φ(y);

FIG. 5 depicts a flowchart of the HOW algorithm implemented by the electronic device;

FIG. 6 depicts a flowchart of primary optimization iteration;

FIG. 7 depicts a flowchart of secondary optimization iteration;

FIG. 8 depicts a further flowchart of the HOW algorithm;

FIG. 9 depicts a schematic diagram of Hyper-spectral imaging restoration results by different algorithms; and

FIG. 10 depicts a schematic diagram of Background and foreground separation results by different algorithms.

### DETAILED DESCRIPTION:

In the following description, a method and an electronic device configured to execute the same for performing a robust low-rank matrix recovery using Hybrid Ordinary-Welsch Function (HOW) by the electronic device and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In this invention, we devise a novel loss function called hybrid ordinary-Welsch (HOW) in which ‘ordinary’ means the quadratic function or the [symbol] ₂-norm, which can overcome the above-mentioned drawbacks. That is to say, the HOW function only changes the weights of outliers when processing the degraded matrix. In addition, the IR generated by HOW can attain sparseness. To the best of our knowledge, we are the first to provide a sparse regularization term corresponding to the correntropy/Welsch function, which is referred to as sparse Welsch implicit regularizer (SWIR), and the solution to its proximal operator is analyzed. In this invention, the HOW function is exploited for robust LRMR via the matrix factorization formulation. Compared with existing loss functions, the effectiveness of HOW is demonstrated by performing two typical tasks of robust LRMR, namely, RMC and RPCA, and the corresponding algorithms are referred to as robust matrix completion via HOW (RMC-HOW) and robust principal component analysis via HOW (RPCA-HOW), respectively.

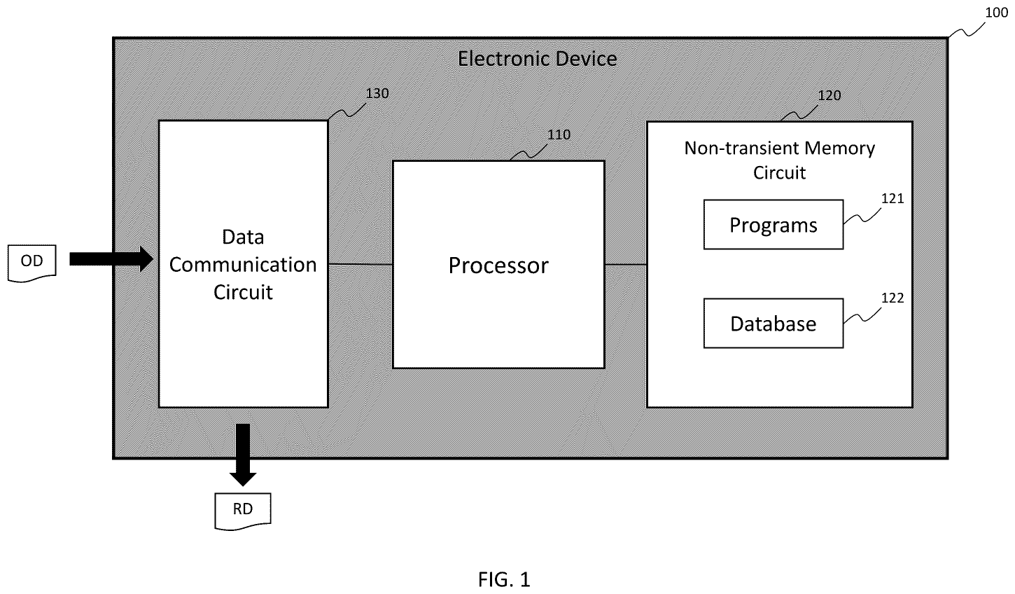

Referring to FIG. 1 in the following description. In accordance with various embodiments of the present invention, provided is an electronic device 100 that includes a processor 110, a non-transient memory circuit 120 and a data communication circuit 130.

The non-transient memory circuit 120 is configured to store machine instructions 121 and to host the database 122. The database 122 may be used to store object data OD, and/or result data RD. The data communication circuit 130 is configured to establish the network connection(s) for receiving the object data OD. and the network connection(s) can be wired or wireless data communication connection(s). Furthermore, the data communication circuit 130 is configured to establish a further network connection for sending the result data RD. The processor 110 executes the machine instructions 121 to implement methods provided by the presented disclosure.

The object data include an incomplete matrix, and the dimensions of the incomplete matrix is m×n. Some of data (entries) in a matrix, by interruption of any kind, are lost (e.g., missing entries) or are determined as not having the original values, as such the matrix is called as an “incomplete matrix”. A complete matrix means that all entries in the matrix are determined as authentic (or not missing) or are determined as having the original values.

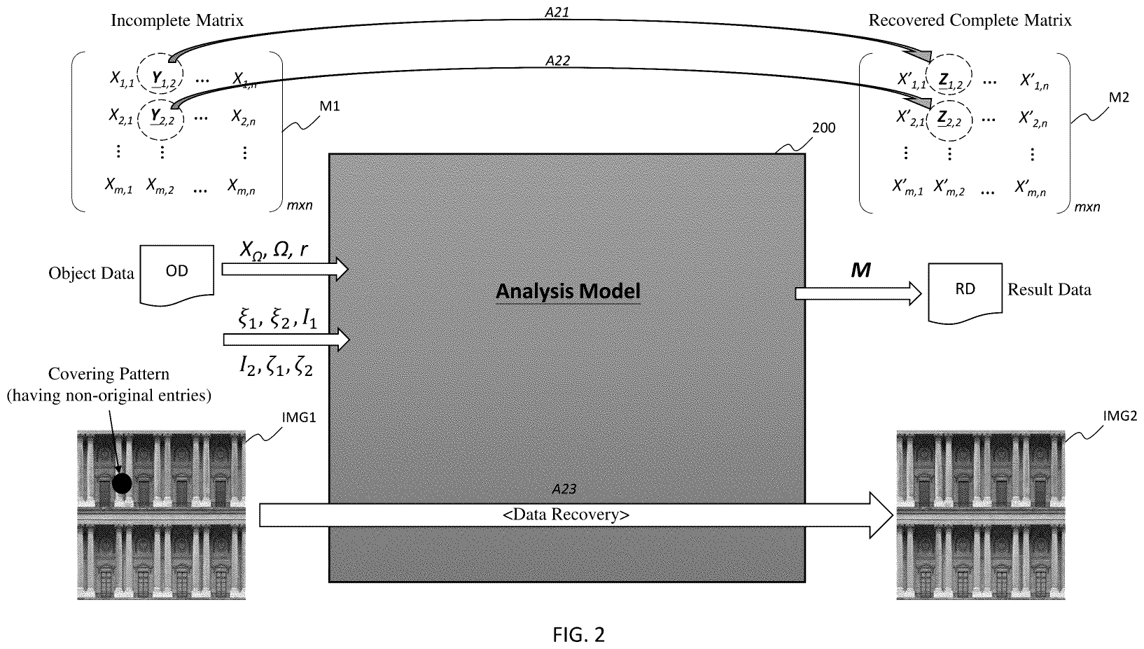

Referring to FIG. 2 in the following description. The incomplete matrix M1 has observed entries (labeled by “X”) and missing entries (labeled by “Y”). The value of each observed entries (e.g., first entries) is known or determined as authentic (being the original value of the desired complete matrix). The value of each missing entries (e.g., second entries) is unknown or determined as not-authentic.

In accordance to one embodiment, the processor 110 executes the analysis model 200 for performing a robust low-rank matrix recovery by analyzing the input data using the HOW algorithm. The input data includes the first values (XQ), the first indexes(Ω) (an incomplete matrix M1), a rank r, a preset first parameter (ξ₁), a preset second parameter (ξ₂), a first maximum iteration number (I₁), a second maximum iteration number (I₂), a first tolerance parameter (ζ₁) and a second tolerance parameter (ζ₂) into an executed analysis model using the HOW algorithm.

The analysis model 200 generates a recovered complete matrix M according to the input data by using the HOW algorithm provided by present disclosure. For example, as illustrated by arrow A21 and A22, the values of missing entries Y_{1,2} and Y_{2,2} of the incomplete matrix M1 is recovered, such that the missing entries Y_{1,2} and Y_{2,2} are recovered as entries Z_{1,2} and Z_{2,2}, and the incomplete matrix M1 is transformed to the recovered complete matrix M2. Then, the processor 110 generates the result data RD having the recovered complete matrix M. The generated result data RD may have auxiliary information related to the object data RD.

For example, for image inpainting, assuming that the interrupted/damaged image IMG1 is received by the processor 110 as the object data OD, wherein a covering pattern is on the image IMG1, the processor 110 determines that the color information of pixels (e.g., missing entries) of the image IMG1 under the covering pattern is missing. The entries other than the missing entries are determined as observed entries, and the values (X_{Ω}) and positions (Ω) of the observed entries are confirmed by the processor 110. Then, the values (X_{Ω}) and positions (Ω) of the observed entries of the image IMG1 is inputted with the first to third parameters into the analysis model to recover the image IMG1 to the image IMG2. As illustrated by arrow A23, the color information (values of pixels) corresponding the missing entries of the image IMG1 is recovered as shown by the image IMG2 in the FIG. 2.

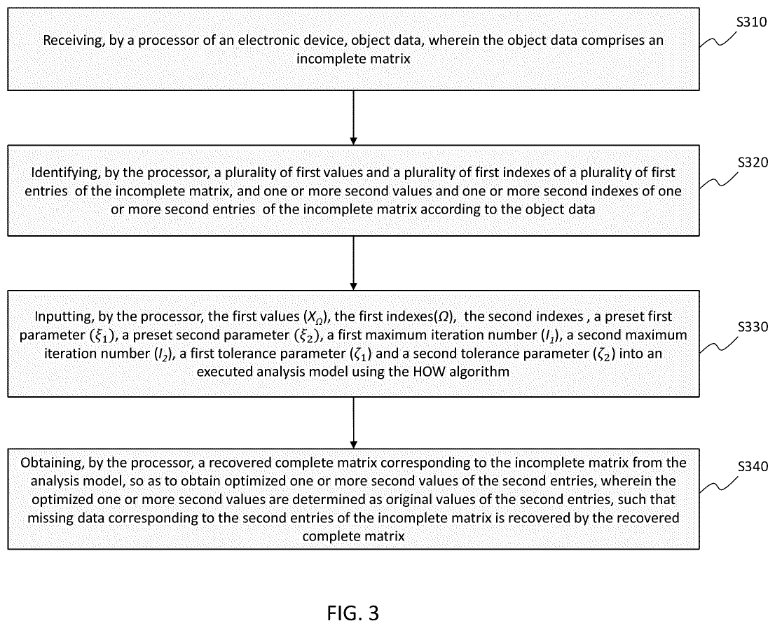

Referring to FIG. 3 in the following description. In step S310, the processor 110 receives one or more object data, wherein the object data comprise at least an incomplete matrix. Next, in step S320, the processor 110 identifies a plurality of first values and a plurality of first indexes of a plurality of first entries of the incomplete matrix, and one or more second values and one or more second indexes of one or more second entries of the incomplete matrix according to the object data. Next, the processor 110 inputs the first values (X_{Ω}), the first indexes(Ω). a rank r, the second indexes, a preset first parameter (ξ₁), a preset second parameter (ξ₂), a first maximum iteration number (I₁), a second maximum iteration number (I₂), a first tolerance parameter (ζ₁) and a second tolerance parameter (ζ₂) into an executed analysis model using the HOW algorithm. Next, the processor 110 obtains a recovered complete matrix corresponding to the incomplete matrix from the analysis model, so as to obtain optimized one or more second values of the second entries, wherein the optimized one or more second values are determined as original values of the second entries, such that missing data corresponding to the second entries of the incomplete matrix is recovered by the recovered complete matrix.

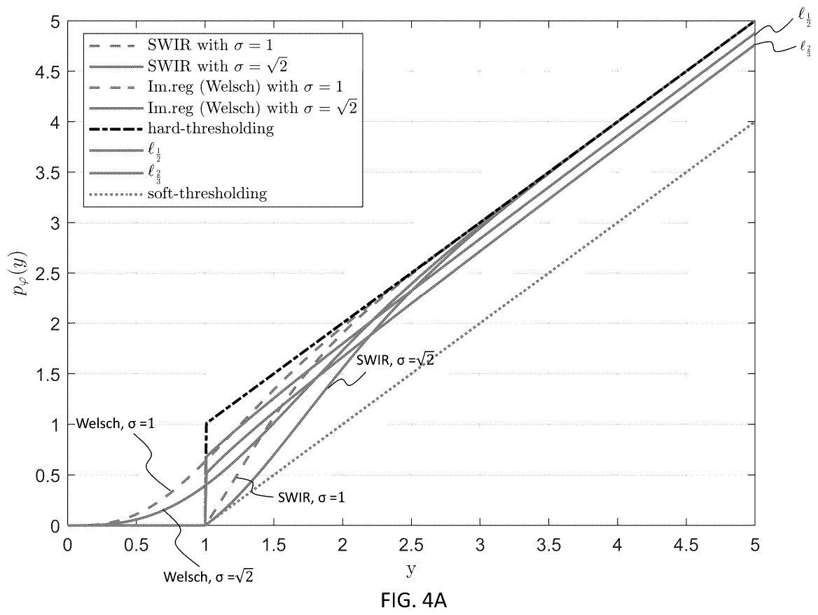

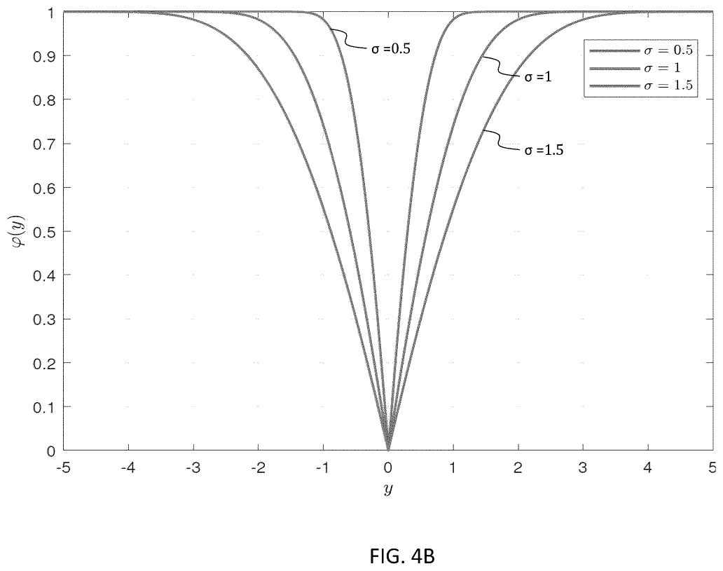

The details of the HOW algorithm are set forth below with reference to FIG. 4A to FIG. 8.

Let X_{Ω}∈ [symbol] ^{m×n} be an incomplete matrix where Ω⊂{1, . . . m}×{1, . . . m n} represents the index set of the observed entries of X, and (·)_{Ω}is a projection operator, that is, [_{Ω}]ᵢⱼ=Xᵢⱼ if (i,j) ∈Ω and 0 otherwise.

The task of matrix completion (MC) is to seek a low-rank matrix M ∈ [symbol] ^{m×n} to approximate the incomplete matrix X_{Ω}and determine the missing entries. Mathematically, it is modeled as a rank minimization problem as presented by equation (1) below:

$$\\ \begin{matrix}{min}_{M} rank ( M ) , s . t . {M}_{Ω} = {X}_{Ω} & ( 1 )\end{matrix}$$

However, equation (1) is non-convex and NP-hard. In practice, the nuclear norm is exploited, leading to equation (2) below:

$$\\ \begin{matrix}{min}_{M} {‖ M ‖}_{*} , s . t . {M}_{Ω} = {X}_{Ω} & ( 2 )\end{matrix}$$

where the nuclear norm ∥M∥_{*} is the sum of singular values of M . Although this is a convex optimization program, it involves performing SVD at each iteration. To circumvent SVD, matrix factorization has been suggested, leading to the following optimization problem as presented by equation (3) below:

$$\\ \begin{matrix}{min}_{U , V} {‖ {X}_{Ω} - {( UV )}_{Ω} ‖}_{F}^{2} & ( 3 )\end{matrix}$$

where U 531 [symbol] ^{m×r} and V ∈ [symbol] ^{r×n} are the two small size matrices with rank r<<min(m, n). Apparently, the restored matrix M=UV^{T} also has low rank. However, its performance is vulnerable to outliers as the [symbol] ₂-norm is adopted.

Next, considering the following optimization problem as presented by equation () below:

$$\\ \begin{matrix}{min}_{X ∈ {ℝ}^{m \times n}} \frac{1}{2} {‖ X - Y ‖}_{F}^{2} + {φ}_{λ} ( X ) & ( 4 )\end{matrix}$$

If the regularizer φ_{λ}(X) is separable, i.e., φ_{λ}(X)=Σ_{i,j}φ_{λ}(X_{i,j}), equation (4) is equal to solving equation (5) presented below:

$$\\ \begin{matrix}{min}_{x} \frac{1}{2} {( x - y )}^{2} + {φ}_{λ} ( x ) & ( 5 )\end{matrix}$$

In an element-wise manner and a scalar solution is defined as presented by equation (6) below:

$$\\ \begin{matrix}{p}_{φ} ( y ) := arg {min}_{x} \frac{1}{2} {( x - y )}^{2} + {φ}_{λ} ( x ) & ( 6 )\end{matrix}$$

Five common penalty functions are tabulated in Table 1 below, and FIG. 4A plots the corresponding p_{φ}(y). When φ_{λ}(·) is chosen as the [symbol] ₀-‘norm’ and [symbol] ₁-norm, equation (4) is known as the hard and soft shrinkage thresholding, respectively. It is worth pointing out that an ideal penalty function makes an estimator to possess the following three properties: (i) Unbiasedness: the solution to x in equation (5) is nearly unbiased when y is large to avoid unnecessary modeling bias; (ii) Sparsity: the solution to x is 0 when y is sufficiently small to reduce model complexity; and (iii) Continuity: the solution to x is continuous to facilitate a stable model. The properties that the five regularizers satisfy are also indicated in Table 1. As shown in FIG. 4A, although the [symbol] _{1/2}-norm and [symbol] _{2/3} -norm can mitigate the bias shrinking problem of the [symbol] ₁-norm, they still have a smaller bias for a finite y (when y→∞, they are unbiased), while p₁₀₀ (y) for the [symbol] ₚ-norm except the [symbol] ₁-norm is discontinuous. Note that for the IR generated by Welsch function, it cannot provide a sparse solution.

TABLE 1
Different regularization functions and their corresponding solutions and properties

| | [symbol] ₀ | ${ℓ}_{\frac{1}{2}}$ | ${ℓ}_{\frac{2}{3}}$ | [symbol] | IR (Welsch) |
|---|---|---|---|---|---|
| ψ [symbol] ( [symbol] ) | λ\|x\| [symbol] | $λ {\vert x \vert}^{\frac{1}{3}}$ | $λ {\vert x \vert}^{\frac{2}{3}}$ | λ\| [symbol] \| | |
| [symbol] | $\{ \begin{matrix}0 , & \vert y \vert < \sqrt{2 λ} \\ \{ 0 , \text{?} \} , & \vert y \vert = \sqrt{2 λ} \\ y , & \vert y \vert > \sqrt{2 λ}\end{matrix}$ | $\{ \begin{matrix}\frac{2}{3} y ( 1 + cos ( \frac{2 π - 2 ϕ ( y )}{3} ) ) , \\ \begin{matrix}\vert y \vert > {ξ}_{1} ( λ ) \\ \begin{matrix}0 , & \vert y \vert > {ξ}_{1} ( λ )\end{matrix}\end{matrix}\end{matrix}$ | $\{ \begin{matrix}( ( w + & {\sqrt{2 y / \text{?} - {\text{?}}^{2} )} / 2 )}^{3} , \\ & \vert y \vert > {ξ}_{2} ( λ ) \\ 0 , & \vert y \vert \leq {ξ}_{2} ( λ )\end{matrix}$ | $\{ \begin{matrix}y + λ , & y < - λ \\ 0 , & \vert y \vert \leq λ \\ y - λ , & y > λ\end{matrix}$ | $y - y \cdot exp ( - \frac{{y}^{{}_{} 2}}{{σ}^{{}_{} 2}} )$ |
| [symbol] | ✓ | x | x | x | ✓ |
| Sparsity | ✓ | ✓ | ✓ | ✓ | x |
| Continuity | x | x | x | ✓ | ✓ |

where, λ is a positive constant, ψ( [symbol] ) = arccos( [symbol] ), ξ₁(λ) = [symbol] , w = [symbol] [symbol] ( [symbol] )/ [symbol] and ξ₂ = 2/3(3(2λ)³ [symbol] . [symbol]
indicates data missing or illegible when filed

Hybrid Ordinary-Welsch Function. The detail of a novel loss function, and a new regularizer via the Legendre-Fenchel transform are presented below. Importantly, this regularizer concurrently satisfies three desirable properties, that is, unbiasedness, sparsity and continuity. The expression of the provided HOW is presented by equation (7) below:

$$\\ \begin{matrix}{l}_{c , σ} ( x ) = \{ \begin{matrix}{x}^{{}_{} 2} / 2 , & \vert x \vert \leq c \\ \frac{{σ}^{{}_{} 2}}{2} ( 1 - {e}^{\frac{{c}^{{}_{} 2} - {x}^{{}_{} 2}}{{σ}^{{}_{} 2}}} ) + \frac{{c}^{{}_{} 2}}{2} , & \vert x \vert > c\end{matrix} & ( 7 )\end{matrix}$$

where c≥0 is a constant corresponding to the maximum magnitude of ‘normal’ data which are noise-free or contaminated only by Gaussian noise, and σ is the kernel size. Note that when c→∞, l_{c,σ}(x) is a quadratic function or [symbol] ₂-norm, and when c=0, l_{c,σ}(x) is the Welsch function. While for 0<c<∞, it is a redescending M-estimator.

Since l_{c,σ} (x) is nonconvex, the Legendre-Fenchel transform is exploited to convert it into a sum of two convex functions with enlarged parameter space. Given a function ƒ(x), its conjugate ƒ*(y) is presented by equation (8) below:

$$\\ \begin{matrix}{f}^{{}_{} *} ( y ) = {sup}_{x} x \cdot y - f ( x ) & ( 8 )\end{matrix}$$

Similarly, the conjugate of ƒ*(y) is presented by equation (9) below:

$$\\ \begin{matrix}{( {f}^{{}_{} *} ( x ) )}^{*} = {sup}_{x} x \cdot y - {f}^{{}_{} *} ( y ) & ( 9 )\end{matrix}$$

The Legendre-Fenchel transform states that if ƒ(x) is a convex function, then ƒ(x)=(ƒ*(x))*. To obtain a convex ƒ(x), by defining equation (10) below:

$$\\ \begin{matrix}\begin{matrix}f ( x ) = \frac{{x}^{{}_{} 2}}{2} - {l}_{c , σ} ( x ) \\ = \{ \begin{matrix}0 , & \vert x \vert \leq c \\ \frac{{x}^{{}_{} 2}}{2} - \frac{{σ}^{{}_{} 2}}{2} ( 1 - {e}^{\frac{{c}^{{}_{} 2} - {x}^{{}_{} 2}}{{σ}^{{}_{} 2}}} ) - \frac{{c}^{{}_{} 2}}{2} , & \vert x \vert > c\end{matrix}\end{matrix} & ( 10 )\end{matrix}$$

Obtaining equation (11) below:

$$\\ \begin{matrix}\begin{matrix}{f}^{{}_{} *} ( y ) = {sup}_{x} x \cdot y - \frac{{x}^{{}_{} 2}}{2} + {l}_{c , σ} ( x ) \\ = {sup}_{x} - \frac{{( y - x )}^{2}}{2} + {l}_{c , σ} ( x ) + \frac{{y}^{{}_{} 2}}{2} \\ = φ ( y ) + \frac{{y}^{{}_{} 2}}{2}\end{matrix} & ( 11 )\end{matrix}$$

where Ω(y) is presented by equation (12) below:

$$\\ \begin{matrix}φ ( y ) = {sup}_{x} - \frac{{( y - x )}^{2}}{2} + {l}_{c , σ} ( x ) & ( 12 )\end{matrix}$$

Since ƒ(x) is convex, obtaining equation (13) below:

$$\\ \begin{matrix}\begin{matrix}f ( x ) = {( {f}^{{}_{} *} ( x ) )}^{*} = {sup}_{y} y \cdot x - {f}^{{}_{} *} ( y ) \\ = {sup}_{y} y \cdot x - φ ( y ) - \frac{{y}^{{}_{} 2}}{2} \\ = {sup}_{y} - \frac{{( y - x )}^{2}}{2} - φ ( y ) + \frac{{x}^{{}_{} 2}}{2}\end{matrix} & ( 13 )\end{matrix}$$

Combining equation (10) and equation (13) yields equation (14) below:

$$\\ \begin{matrix}{l}_{c , σ} ( x ) = {inf}_{y} \frac{{( y - x )}^{2}}{2} + φ ( y ) & ( 14 )\end{matrix}$$

which is called the Moreau envelope of φ(y). In general, the exact expression of φ(y), which is called SWIR, is unknown. As an illustration, it is computed numerically for several values of σ and the results are plotted in FIG. 4B. There are 4 properties of φ(y) as follows: (i) φ(y) is symmetric, i.e., φ(y)=φ(−y); (ii) φ(y) is continuous, but nonsmooth at φ=0; (iii) φ(y) is nonnegative and increasing when y>0; (iv) φ(y) satisfies the triangle inequality, i.e., φ(y₁+y₂)≤φ(y₁)+φ(y₂) for any y₁, y₂ ∈ [symbol] .

Actually, equation (14) can be considered as the proximal mapping of φ(y), and its solution is given in the following proposition.

$$\\ g ( y ) = \frac{{( y - x )}^{2}}{2} + φ ( y )$$

Proposition 1. The function is convex, and the solution to y in equation (14) is presented by equation (15) below:

p_{φ}(x):=max{0, |x|−|x|·e^{(c}^{²}^{-x}^{²}^{)/σ}^{²}}sign(x) (15)

In addition, p_{φ}(x) is monotonic, namely, for any x₁<x₂, p_{φ}(x₁)≤p_{φ}(φ₂).

On the other hand, the relation between c and σ in equation (7) is provided in the following proposition.

Proposition 2. The parameters c and σ control the robustness of l_{c,σ}(x) and they satisfy

$$\\ c \geq \frac{σ}{\sqrt{2}} .$$

In the embodiment, the HOW is applied to LRMR to resist outliers. Adopting matrix factorization, the provided formulation is presented by equation (16) below:

$$\\ \begin{matrix}{min}_{U , V} {}_{} {l}_{c , σ} ( {X}_{Ω} - {( UV )}_{Ω} ) & ( 16 )\end{matrix}$$

where l_{c,σ}(X_{Ω}−(UV)_{Ω}) is separable, i.e., l_{c,σ}(X_{Ω}−(UV)(_{Ω})=Σ_{i,j∈Ω}l_{c,σ}(X_{i,j}−(UV)_{i,j}). According to equation (14), having the augmented problem of equation (16) as presented by equation (17) below:

$$\\ \begin{matrix}{min}_{U , V , S} \frac{1}{2} {\sum }_{i , j ∈ Ω} {( {X}_{i , j} - {( UV )}_{i , j} - {S}_{i , j} )}^{2} + φ ( {S}_{i , j} ) & ( 17 )\end{matrix}$$

such that φ(S)=Σ_{i,j}φ(S_{i,j}), and S_{φc}=0 where φ^{c} is the complement of φ. Then, equation (17) can be rewritten as equation (18) below:

$$\\ \begin{matrix}{min}_{U , V , S} \frac{1}{2} {‖ {X}_{Ω} - {( UV )}_{Ω} - {S}_{Ω} ‖}_{F}^{2} + φ ( {S}_{Ω} ) & ( 18 )\end{matrix}$$

It is seen that if S_{Ω}is fixed, equation (18) becomes a quadratic optimization problem, implying that traditional optimization algorithms under Gaussian noise can be utilized. In our study, scaled alternating steepest descent (SASD) is adopted to find U and V in equation (18) in an iterative manner. The solution to S is computed first. S is a sparse matrix introduced by the Legendre-Ferchel transform, which is used to find outliers. In the (k+1)th iteration, given U^{k} and V^{k}, equation (18) is equal to equation (19) below:

$$\\ \begin{matrix}{min}_{S} \frac{1}{2} {‖ {D}_{Ω}^{{}_{} k} - {S}_{Ω} ‖}_{F}^{2} + φ ( {S}_{Ω} ) & ( 19 )\end{matrix}$$

where D^{K}=X−U^{k}V^{k}. Since φ(S) is separable, according to Proposition 1, the solution to equation (19) is presented by equation (20) below:

S_{Ω}^{k+1}=p_{φ}(D_{Ω}^{k}) (20)

Given S^{k+1}, equation (18) becomes:

$$\\ \begin{matrix}{min}_{U , V} {}_{} h ( U , V ) := \frac{1}{2} {‖ {H}_{Ω}^{{}_{} k + 1} - {( UV )}_{Ω} ‖}_{F}^{2} & ( 21 )\end{matrix}$$

where H_{Ω}^{k+1}=X_{Ω}−S_{Ω}^{k+1}, and it can be efficiently solved by the SASD. For a fixed V, the gradient of h(U, V) w.r.t. U is presented by equation (22) below:

∇h_{V}(U)=−(H_{Ω}−(UV)_{Ω})V^{T} (22)

The corresponding step size μ_{U} is calculated as presented by equation (23) below:

$$\\ \begin{matrix}\begin{matrix}{μ}_{U} := arg {min}_{μ} \frac{1}{2} {‖ {H}_{Ω} - {( ( U - μ ∇ {h}_{V} ( U ) ) V )}_{Ω} ‖}_{F}^{2} \\ = {‖ ∇ {h}_{V} ( U ) ‖}_{F}^{2} / {‖ {( ∇ {h}_{V} ( U ) V )}_{Ω} ‖}_{F}^{2}\end{matrix} & ( 23 )\end{matrix}$$

and obtaining:

U^{k+1}=U^{k}−μ_{U}^{k}∇h_{V}_{^{k}}(U^{k}) (24)

Similarly, given U, the gradient of h(U, V) w.r.t. V is presented by equation (25) below:

∇h_{U}(V)=−U^{T}(H_{Ω}−(UV)_{Ω}) (25)

The corresponding step size is presented by equation (26) below:

μ_{V}=∥∇h_{U}(V)∥_{F}²/∥(U∇h_{U}(V)_{Ω}∥_{F}² (26)

Then, obtaining:

V^{k+1}=V^{k}−μ_{V}^{k}∇h_{U}_{^{k+1}}(V^{k}) (27)

The steps from equation (22) to equation (27) are referred to as the alternating steepest descent (ASD) method. The accelerated version of ASD, SASD, obtained by scaling the gradient descent directions ∇h_{V}(U) and ∇h_{U}(V) with (VV^{T})⁻¹ and (U^{T}U)⁻¹, respectively, has been verified to have better performance than ASD. The gradient descent directions of SASD for introduced case are then presented by equations (28) and (29) below:

\tilde{∇}h_{V}(U)=(H_{Ω}−(UV)_{Ω})V^{T}(VV^{T})⁻¹ (28)

\tilde{∇}h_{U}(V)=(U^{T}U)⁻¹U^{T}(H_{Ω}−(UV)_{Ω}) (29)

And the corresponding step sizes are presented by equations (30) and (31) below:

\tilde{μ}_{U}= [symbol] ∇h_{V}(U),\tilde{∇}h_{V}(U) [symbol] /∥(\tilde{∇}h_{V}(U)V)_{Ω}∥_{F}² (30)

\tilde{μ}_{V}= [symbol] ∇h_{U}(V),\tilde{∇}h_{U}(V) [symbol] /∥(U\tilde{∇}h_{U}(V))_{Ω}∥_{F}² (31)

Finally, the SASD updates for U and V are presented by equations (32) and (33) below:

U^{k+1}=U^{k}−\tilde{μ}_{U}^{k}\tilde{∇}h_{V}_{^{k}}(U^{k}) (32)

V^{k+1}=V^{k}−\tilde{μ}_{V}^{k}\tilde{∇}h_{U}_{^{k+1}}(V^{k}) (33)

While setting the values of c and σ, which control the robustness of equation (16), as presented by equation (34):

c^{k}=min{ξ₁d^{k},c^{k-1}};σ^{k}=min{ξ₂d^{k},σ^{k-1}} (34)

where ξ₁>0 and ξ₂>0 are constants, d^{k} is the robust normalized interquartile range of the vectorized D_{Ω}, which is computed by equation (35) below:

d^{k}=IQR(vec(D₁₀₆^{k}))/1.349 (35)

with IQR(·) being the sample interquartile range operator. Besides, in order to achieve stable recovery results, the solution to equation (3) is first computed to provide good initialization for U and V. In other words, equations (32) and (33) are first performed for a few iterations and then the optimization is switched to the RMC (robust matrix completion) procedure with S being updated together.

The proposed RMC procedure is summarized in Algorithm 1 below.

```
Algorithm 1 Robust matrix completion via HOW (RMC-HOW)
  Input: Incomplete matrix X_{Ω}, rank r, index set Ω, ξ₁, ξ₂, maximum allowable
  iteration numbers I₁ and I₂, and tolerance parameters ζ₁ and ζ₂
    Initialize: Generate a standard Gaussian matrix V⁰ E [symbol]    ^{r×n} and define S =
  0.
    for k = 1, 2, . . . , I₁ do
      Find the solution to U^{k} according to (32)
      Find the solution to V^{k} according to (33)
      Stop, if rel_{E}^{k} ≤ ζ₁.
    end for
    Set U⁰ = U^{k} and V⁰ = V^{k}
    for k = 1, 2, . . . , I₂ do
      Calculate c^{k} and σ^{k} according to (34)
      Find the solution to S^{k} according to (20)
      Find the solution to U^{k} according to (32)
      Find the solution to V^{k} according to (33)
      Stop, if rel_{E}^{k} ≤ ζ₂.
    end for
  Output: M = U^{k}V^{k} and S = S^{k}.
```

Defining Eₖ=l_{c,σ}(X_{Ω}−(U^{k}V^{k})_{Ω}) and the relative error rel_{E}^{k}=(Eₖ−Eₖ₋₁)/Eₖ₋₁, and if rel_{E}^{k} is less than a threshold, saying that the solutions satisfy the convergence condition. Besides, defining [symbol] _{c,σ}(U, V, S)=½∥X_{Ω}−(UV)_{Ω}−S_{Ω}∥_{F}²+φ(S_{Ω}), and the convergence of Algorithm 1 is analyzed in the following two theorems.

Theorem 1. The sequence { [symbol] _{c}_{^{k}}_{,σ}_{^{k}}(U^{k}, V^{k}, S^{k}), k=1, 2, . . . } generated by Algorithm 1 converges.

Theorem 2. Let {(U^{k}, V^{k}, S^{k})} be the sequence generated by Algorithm 1, and suppose that (U^{k}, V^{k}) are of full rank. Let {(U^{k}^{ⱼ}, V^{k}^{ⱼ}, S^{k}^{ⱼ})} be a bounded subsequence of {(U^{k}, V^{k}, S^{k})} such that limₖ_{_{j→∞}}U^{k}^{ⱼ}=U*, limₖ_{_{j→∞}}V^{k}^{ⱼ}=V* and limₖ_{_{j→∞}}S^{k}^{ⱼ}=S*. Then, (U*, V*, S*) is a critical point of equation (18).

The computational requirement of Algorithm 1 is dominated by the SASD, whose complexity is [symbol] (8|Ω|r+4(m+n)r²) at each iteration. When taking the computation of S_{Ω} into consideration, the total complexity becomes [symbol] (|Ω|(8r+1)+4(m+n)r²) per iteration.

Although Algorithm 1 is designed for RMC, it is clear that RPCA is the special case of RMC when all entries are observed. Referring the corresponding algorithm to as robust principal component analysis via HOW (RPCA-HOW).

Since the Welsch function is a special case of HOW when c=0, Algorithm 1 can also realize the Welsch-based RMC and RPCA, referred to as RMC-Welsch and RPCA-Welsch, respectively.

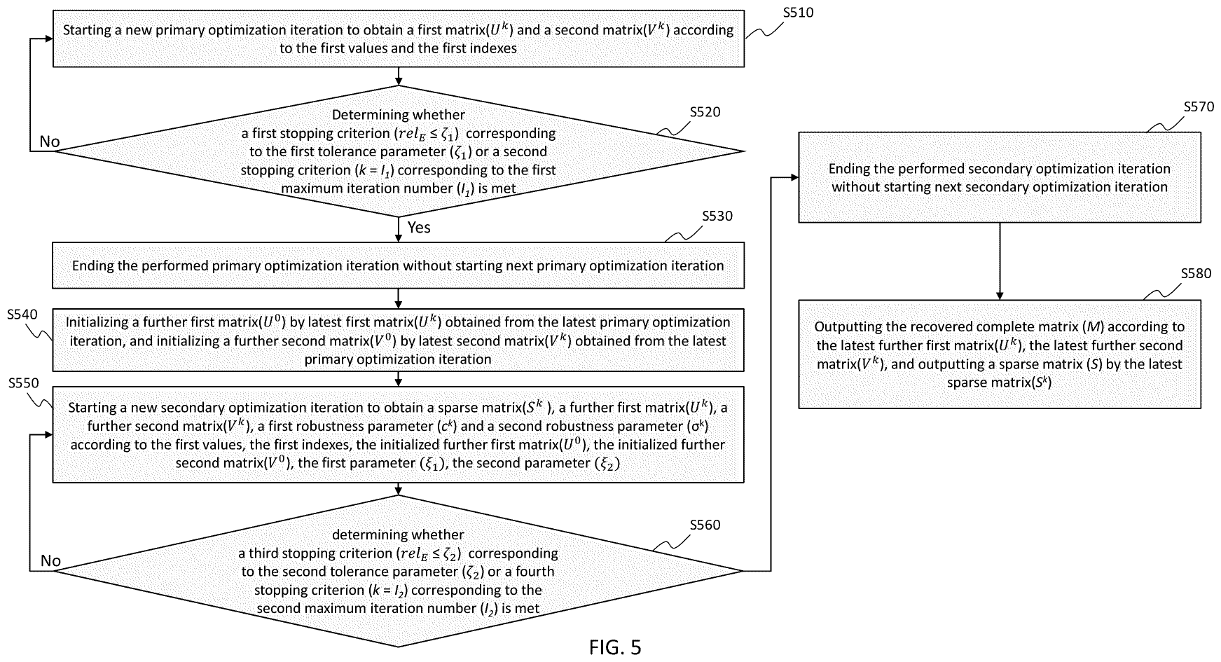

Referring to FIG. 5, algorithm 1 can be summarized as steps S510 to S580.

In step S510, the processor 110 (executing the analysis model), starts a new primary optimization iteration to obtain a first matrix (U^{k}) and a second matrix (V^{k}) according to the first values and the first indexes. The first values of the first entries are determined as original values of the first entries, and the first entries are the observed entries of the received incomplete matrix.

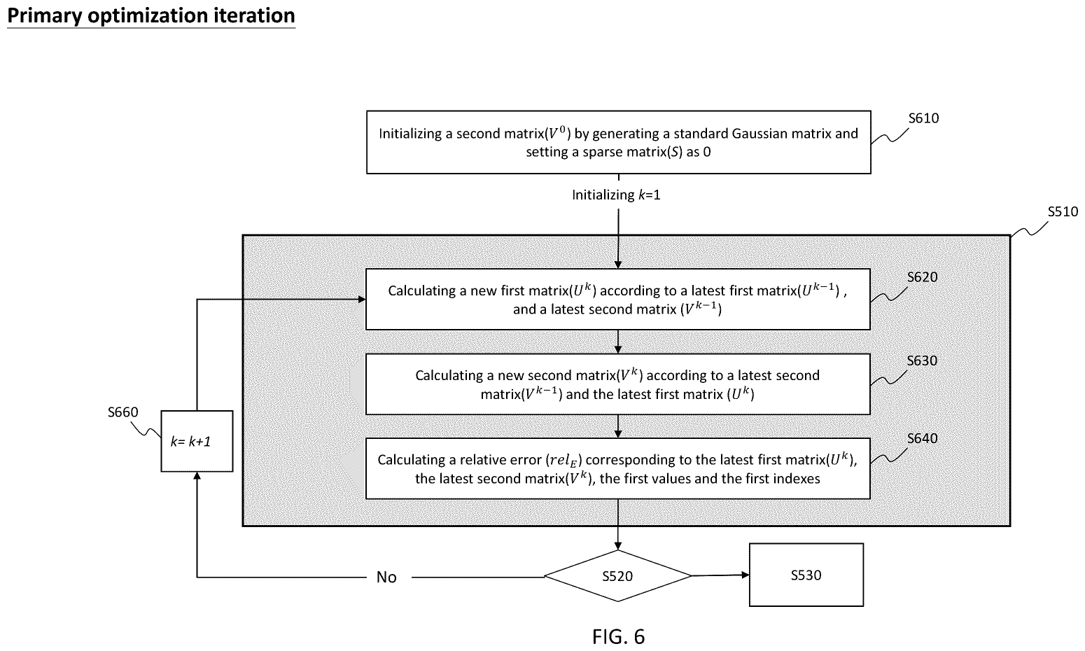

In more detail, referring to FIG. 6, before performing the primary optimization iteration, the method further includes: analysis model initializes a second matrix (V⁰) by generating a standard Gaussian matrix and setting a sparse matrix (S) as 0 (step S610); and initializes k as 1, wherein k indicates the number of the performed primary optimization iteration.

The primary optimization iteration includes steps S620 to S640.

In step S620, the analysis model calculates a new first matrix (U^{k}) according to a latest first matrix (U^{k-1}), and a latest second matrix (V^{k-1}). Next, in step S630, the analysis model calculates a new second matrix (V^{k}) according to a latest second matrix (V^{k-1}), and the latest first matrix (U^{k}). Next, in step S640, the analysis model calculates a relative error (rel_{E}) corresponding to the latest first matrix (U^{k}), the latest second matrix (V^{k}), the first values and the first indexes.

If the first stopping criterion and the second stopping criterion are determined both not met (S520→No), k is added by 1 (S650) and continuing to step 1 of the next primary optimization iteration. If the relative error (rel_{E}) is smaller or equal to the first tolerance parameter (ζ₁), determining that the first stopping criterion is met; and if the k is equal to the first maximum iteration number (I₁), determining that the second stopping criterion is met.

Returning to FIG. 5, next, in step S520, the analysis model determines whether a first stopping criterion (rel_{E}≤ζ₁) corresponding to the first tolerance parameter (ζ₁) or a second stopping criterion (k=I₁) corresponding to the first maximum iteration number (I₁) is met.

If the first stopping criterion and the second stopping criterion are both not met, returning to step S510, to start next primary optimization iteration.

If the first stopping criterion or the second stopping criterion is met, continue to step S530, the analysis model ends the performed primary optimization iteration without starting next primary optimization iteration (i.e., the whole primary optimization iterations process is completed). Next, in step S540, the analysis model initializes a further first matrix (U⁰) by latest first matrix (U^{k}) obtained from the latest primary optimization iteration (i.e., U⁰=U^{k}), and initializing a further second matrix (V⁰) by latest second matrix (V^{k}) obtained from the latest primary optimization iteration (i.e., V⁰=V^{k}).

Next, in step S550, the analysis model Starting a new secondary optimization iteration to obtain a sparse matrix (S^{k}), a further first matrix (U^{k}), a further second matrix (V^{k}), a first robustness parameter (c^{k}) and a second robustness parameter (σ^{k}) according to the first values, the first indexes, the initialized further first matrix (U⁰), the initialized further second matrix (V⁰), the first parameter (ξ₁), the second parameter (ξ₂). The first and second parameters are related to the first robustness parameter (c^{k}) and a second robustness parameter (σ^{k}) during the iterations.

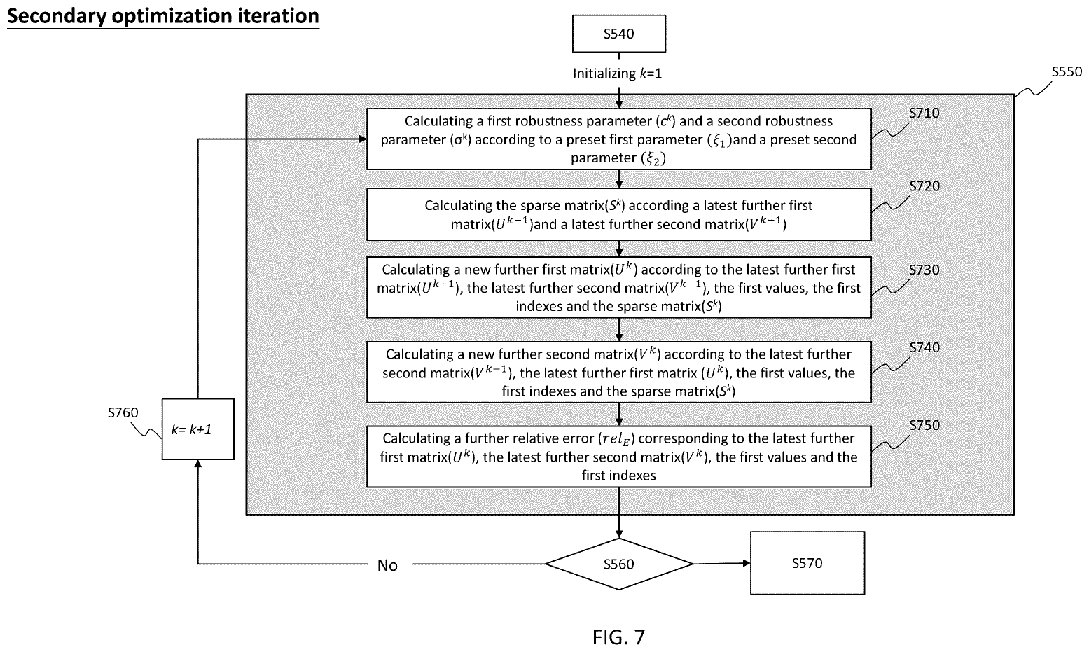

In more detail, referring to FIG. 7, before performing the secondary optimization iteration, the method further includes: analysis model initializes k as 1, wherein k indicates the number of the performed secondary optimization iteration (also, the initialized further first matrix (U⁰) and initialized further second matrix (V⁰) are obtained via step S540).

The secondary optimization iteration includes steps S710 to S750.

In step S710, the analysis model calculates a first robustness parameter (c^{k}) and a second robustness parameter (σ^{k}) according to the preset first parameter (ξ₁) and the preset second parameter (ξ₂) (e.g., calculated by equation (34));

Next, in step S720, the analysis model calculates the sparse matrix (S^{k}) according to a latest further first matrix (U^{k-1}) and a latest further second matrix (V^{k-1}). Next, in step S730, the analysis model calculates a new further first matrix (U^{k}) according to the latest further first matrix (U^{k-1}), the latest further second matrix (V^{k-1}), the first values, the first indexes and the sparse matrix (S^{k}). Next, in step S740, the analysis model calculates a new further second matrix (V^{k}) according to the latest further second matrix (V^{k-1}), the latest further first matrix (U^{k}), the first values, the first indexes and the sparse matrix (S^{k}). Next, in step S750, the analysis model calculates a further relative error (rel_{E}) corresponding to the latest further first matrix (U^{k}), the latest further second matrix (V^{k}), the first values and the first indexes.

If the third stopping criterion and the fourth stopping criterion are determined both not met (S560→No), k is added by 1 (S760) and continuing to step 1 of the next secondary optimization iteration. If the further relative error (rel_{E}) is smaller or equal to the second tolerance parameter (ζ₂), determining that the third stopping criterion is met; and if the k is equal to the second maximum iteration number (I₂), determining that the fourth stopping criterion is met.

Returning to FIG. 5, in step S560, the analysis model determines whether a third stopping criterion (rel_{E}≤ζ₂) corresponding to the second tolerance parameter (ζ₂) or a fourth stopping criterion (k=i₂) corresponding to the second maximum iteration number (I₂) is met.

If the third stopping criterion and the fourth stopping criterion are both not met, returning to step S550, the analysis model, starts next secondary optimization iteration.

If the third stopping criterion or the fourth stopping criterion is met, continue to step S570, the analysis model ends the performed secondary optimization iteration without starting next secondary optimization iteration (i.e., the whole secondary optimization iterations process is completed).

Next, in step S580, the analysis model outputs the recovered complete matrix (M) according to the latest further first matrix (U^{k}), the latest further second matrix (V^{k}), and outputting a sparse matrix (S) by the latest sparse matrix (S^{k}). The recovered complete matrix (M) is calculated by an equation: M=U^{k}V^{k}, wherein U^{k} denotes the latest further first matrix obtained from the secondary optimization iterations; and V^{k} denotes the latest further second matrix obtained from the secondary optimization iterations.

It should be mentioned that the first matrix or the further first matrix is calculated by equation (32), U^{k+1}=U^{k}−\tilde{μ}_{U}^{k}\tilde{∇}h_{V}_{^{k}}(U^{k}), wherein \tilde{μ}_{U}^{k} denotes a step size corresponding to the first matrix or the further first matrix; and \tilde{∇}h_{V}_{^{k}}(·) denotes a gradient descent direction function corresponding to the first matrix or the further first matrix; and the second matrix or the further second matrix is calculated by equation (33), V^{k+1}=V^{k}−\tilde{μ}_{V}^{k}\tilde{∇}h_{U}_{^{k}}(V^{k}), wherein \tilde{μ}_{V}^{k} denotes a step size corresponding to the first matrix or the further first matrix; and \tilde{∇}h_{U}_{^{k}}(·) denotes a gradient descent direction function corresponding to the first matrix or the further first matrix.

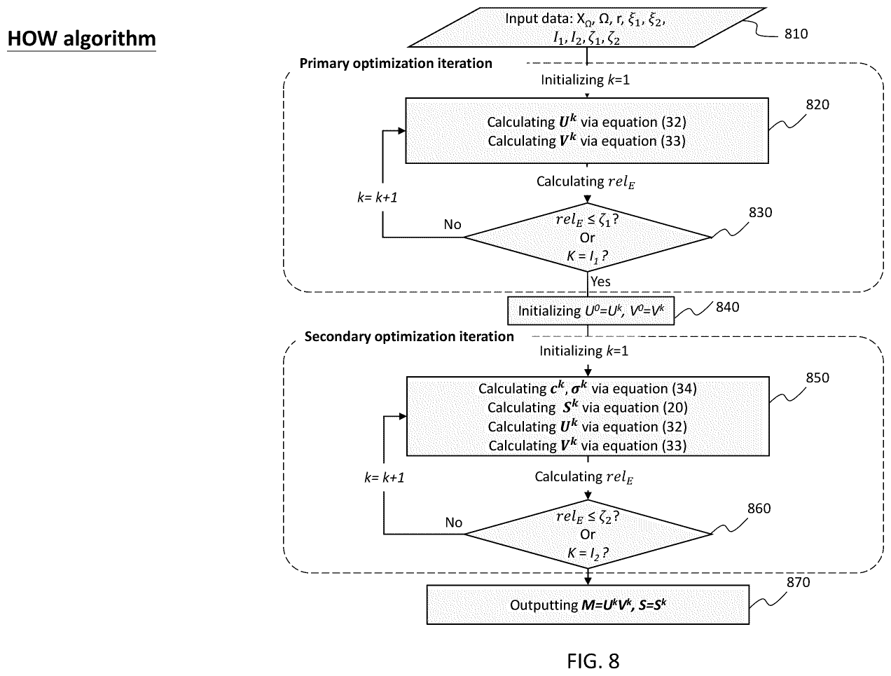

Referring to FIG. 8 in the following description. According to Algorithm 1, in block 810, the processor 110 executing the analysis model 200 receives the input data, X_{Ω}, Ω, r, ξ₁, ξ₂, I₁, ζ₁, ζ₂. The r indicates a rank of the incomplete matrix. Then, the processor 110 performs primary optimization iteration process, initializes k as 1, calculates a first matrix (U^{k}) and a second matrix (V^{k}) via equations (32) and (33) during each iteration (Block 820). Then, the processor 110 calculates the relative error rel_{E} for being used for determining first stopping criterion in block 830. Then, in block 830, the processor 110 determines whether rel_{E}≤ζ₁ or k=I₁ is met. If rel_{E}≤ζ₁ or k=I₁, the whole primary optimization iterations process is completed, proceeding block 840 where the processor 110 initializes U⁰=U^{k}, V⁰=V^{k}.

Then, the processor 110 performs secondary optimization iteration process. Firstly, the processor 110 initializes k as 1, then in block 850, the processor calculates a first robustness parameter (c^{k}) and a second robustness parameter (σ^{k}), a sparse matrix (S^{k}), a further first matrix (U^{k}), a further second matrix (V^{k}) via equations (34), (20), (32) and (33) during each iteration.

Then, the processor 110 calculates a further relative error rel_{E} for being used for determining third stopping criterion in block 860. Then, in block 860, the processor 110 determines whether rel_{E}≤₂ or k=I_{2 i}s met. If rel_{E}≤₂ or k=I₂, the whole secondary optimization iterations process is completed, proceeding block 870. In block 870, the processor 110, outputs the recovered complete matrix (M) according to the latest further first matrix (U^{k}), the latest further second matrix (V^{k}), and outputs a sparse matrix (S) by the latest sparse matrix (S^{k}).

For the HOW, there are two parameters, i.e., c and σ, affecting its performance when resisting outliers. Thus, we analyze their sensitivity via conducting 100 independent runs. Finding that for different SNRs and matrix dimensions, Algorithm 1 can work well for a wide range of {ξ₁, ξ₂}, and we set ξ₁=2 and ξ₂=2.3. When their values are too small, HOW will approach the Welsch M-estimator with very small kernel size, which causes the weight of normal data to drop rapidly, leading to an inferior solution.

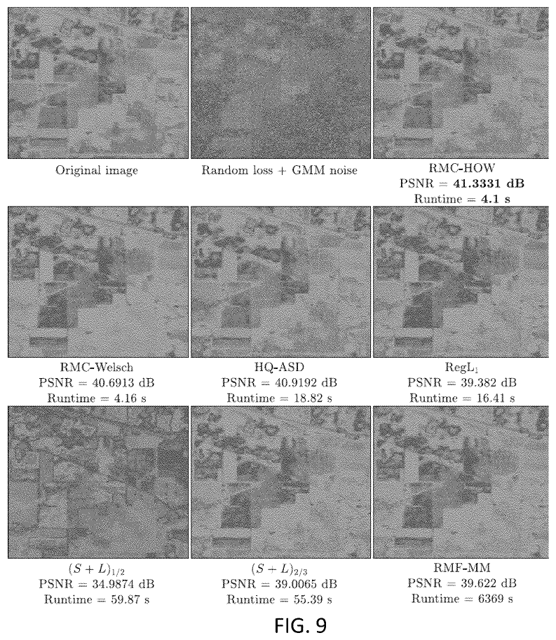

In an example of RMC-HOW, HOW algorithm can be applied to a RMC application such as Hyperspectral imaging. Hyper-spectral imaging (HSI) has numerous applications such as earth climate, agriculture and urban planning. However, it may lose some data and be corrupted by Gaussian noise and impulsive noise, due to photon effects and calibration error. Thus, it is necessary to improve the HSI quality prior to its subsequent processing. In this example, employing the proposed method to recover the degraded HSI and resist outliers. Indian Pines dataset is used, whose dimensions are 145×145 pixels per band with 200 bands. Then, the data matrix X∈ [symbol] ^{21025×200} is constructed, whose columns comprise vectorized bands of the Indian Pines data. In addition, 20% of pixels in X are randomly missing, 10 dB impulsive noise generated by GMM is added to the incomplete data. FIG. 9 displays the restoration results (including PSNR value and runtime) of different methods. It is seen that compared with the competing methods, the proposed algorithm achieves better recovery results and has the “least” computational time.

In another example of RPCA-HOW, The HOW algorithm can be applied into background-foreground separation, which can be modeled as a RPCA problem since the background in videos and the moving objects in foreground can be considered as the low-rank and sparse components, respectively.

Assuming that taking six videos from the CDnet dataset, namely, Cubicle (240×352 for each frame), Highway (240×320), Skating (180×270), Overpass (240×320), Blizzard (240×360) and Corridor (240×320), are employed. Besides, 200 frames for each video are chosen and then vectorized to generate the data matrix. zero-mean Gaussian noise with variance being 0.001 is added into the data matrix. For these videos, assuming that the background is approximately static, thus the rank of the background matrix is one. To numerically evaluate the performance, four metrics, namely, iteration number (Iter.), runtime in seconds, sparseness in foreground (∥S∥₀/mn) and F-measure, are adopted. Given the true positive (TP), false positive (FP), false negative (FN) and true negative (TN), F-measure is defined as equation (36) below:

$$\\ \begin{matrix}{F}_{m} = \frac{2 \times precision \times recall}{precision + recall} & ( 36 )\end{matrix}$$

$$\\ Where precision = \frac{TP}{TP + FP} and recall = \frac{TP}{TP + FN} .$$

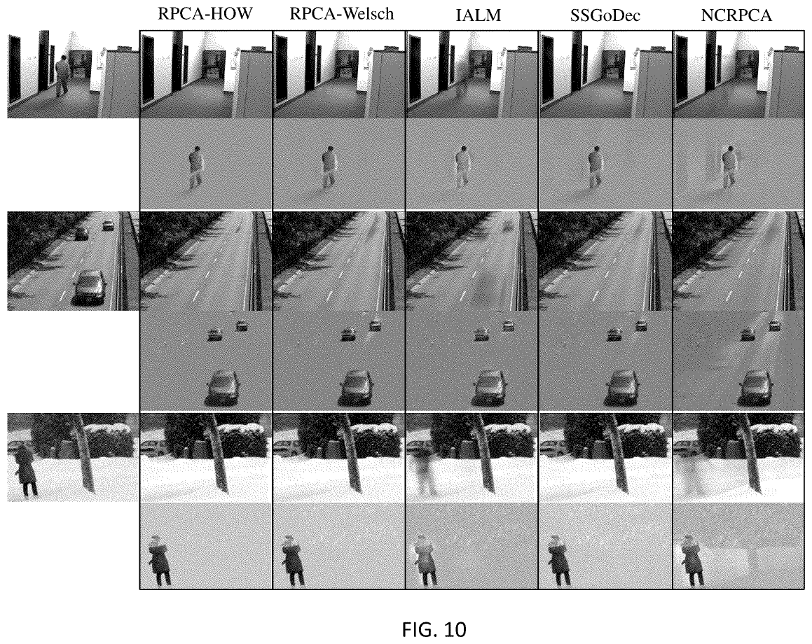

The numerical results of different algorithms and the visual results of representative frames for the surveillance videos are shown in Table 2 below and FIG. 10, respectively.

TABLE 2
Quantitative results on background and foreground separation

| | Cubicle | | | | Highway | | | | Skating | | | |
|---|---|---|---|---|---|---|---|---|---|---|---|---|
| Method | [symbol] | Time | [symbol] | [symbol] | [symbol] | Time | [symbol] | [symbol] | [symbol] | Time | [symbol] | [symbol] |
| RPCA-HOW | 9 | 6.89 | 0.050 | 0.7276 | 12 | 9.29 | 0.077 | 0.6191 | 8 | 3.35 | 0.060 | 0.6323 |
| RPCA · Welsch | 13 | 10.7 | 1 | 0.7231 | 13 | 9.61 | 1 | 0.6031 | 12 | 5.68 | 1 | 0.6319 |
| IALM | 117 | 91.3 | 0.962 | 0.5372 | 126 | 97.3 | 0.933 | 0.6128 | 122 | 35.6 | 0.945 | 0.5791 |
| SSGoDec | 101 | 20.7 | 0.893 | 0.7255 | 101 | 19.0 | 0.922 | 0.6119 | 101 | 12.4 | 0.906 | 0.6313 |
| NCRPCA | 63 | 63.6 | | 0.5838 | 100 | 88.1 | 1 | 0.5256 | 62 | 32.5 | 1 | 0.5794 |

[symbol]

[symbol]

indicates data missing or illegible when filed

It is seen that obvious ghosting exists in the backgrounds obtained by IALM and NCRPCA in the first and third videos. Besides, in the second video, the shadows on the road are minimal in the background obtained by our method, compared to the remaining approaches. We easily observe that RPCA-HOW obtains a more sparse foreground since the foreground generated by RPCA-Welsch, IALM(linearized alternating direction method), SSGoDec [T. Zhou and D. Tao, “Shifted subspaces tracking on sparse outlier for motion segmentation.” in Proceedings of International Joint Conferences on Artificial Intelligence, Beijing, China, Aug. 2013, pp. 1946-1952] and NCRPCA(nonconvex regularization principal component analysis) still contain some apparent noise, which corresponds to the numerical results of ∥S∥₀/mn in Table 2. These also demonstrate that the RPCA-HOW outperforms the competing methods in terms of iteration number, running time, sparsity and F-measure.

Based on experimental results with synthetic data and real-world applications in hyperspectral imaging, and background/foreground separation, it is demonstrated that the proposed approach outperforms the state-of-the-art methods in terms of recovery accuracy and runtime.

Furthermore, the advantages of the invention over existing technologies and works are: (1) The invention, HOW, unlike existing robust functions including the well-known Welsch function, does not down-weigh the ‘normal’ data while it is not sensitive to gross errors with big magnitudes. The corresponding regularizer concurrently satisfies three desirable properties, namely, unbiasedness, sparsity and continuity, whereas the penalty functions in the literature cannot. (2) The invention, RMC-HOW, outperforms the conventional robust matrix completion techniques in terms of restoration performance and runtime, particularly in the applications of hyperspectral imaging. (3) The invention, RPCA-HOW, also outperforms the conventional robust principal component analysis techniques, particularly in the applications of video foreground/background separation.

The functional units of the apparatuses and the methods in accordance to embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance to various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local

Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A computer-implemented method for performing a robust low-rank matrix recovery using Hybrid Ordinary-Welsch Function (HOW) by an electronic device, comprising:
receiving, by a processor of the electronic device, object data, wherein the object data comprises an incomplete matrix, wherein the incomplete matrix is a low-rank matrix;
identifying, by the processor, a plurality of first values and a plurality of first indexes of a plurality of first entries of the incomplete matrix, and one or more second values and one or more second indexes of one or more second entries of the incomplete matrix according to the object data,
wherein the first values of the first entries are determined as original values of the first entries, and the one or more second values of the second entries are determined as non-original values of the second entries;
inputting, by the processor, the first values (X_{Ω}), the first indexes(Ω), a rank r, the second indexes, a preset first parameter (ξ₁), a preset second parameter (ξ₂), a first maximum iteration number (I₁), a second maximum iteration number (I₂), a first tolerance parameter (ζ₁) and a second tolerance parameter (ζ₂) into an executed analysis model using HOW algorithm; and
obtaining, by the processor, a recovered complete matrix corresponding to the incomplete matrix from the analysis model, so as to obtain optimized one or more second values of the second entries, wherein the optimized one or more second values are determined as original values of the second entries, such that missing data corresponding to the second entries of the incomplete matrix is recovered by the recovered complete matrix.

2. The method of claim 1, further comprising:
starting, by the analysis model, a new primary optimization iteration to obtain a first matrix (U^{k}) and a second matrix (V^{k}) according to the first values and the first indexes;
determining, by the analysis model, whether a first stopping criterion (rel_{E}≤ζ₁) corresponding to the first tolerance parameter (ζ₁) or a second stopping criterion (k=I₁) corresponding to the first maximum iteration number (I₁) is met;
if the first stopping criterion and the second stopping criterion are both not met, starting, by the analysis model, next primary optimization iteration; and
if the first stopping criterion or the second stopping criterion is met,
ending, by the analysis model, the performed primary optimization iteration without starting next primary optimization iteration;
initializing, by the analysis model, a further first matrix (U⁰) by latest first matrix (U^{k}) obtained from the latest primary optimization iteration, and initializing a further second matrix (V⁰) by latest second matrix (V^{k}) obtained from the latest primary optimization iteration; and
starting, by the analysis model, a new secondary optimization iteration to obtain a further first matrix (U^{k}), a further second matrix (V^{k}), a sparse matrix (S^{k}), a first robustness parameter (c^{k}) and a second robustness parameter (σ^{k}) according to the first values, the first indexes, the initialized further first matrix (U⁰), the initialized further second matrix (V⁰), the first parameter (ξ₁), the second parameter (ξ₂);
determining, by the analysis model, whether a third stopping criterion (rel_{E}≤ζ₂) corresponding to the second tolerance parameter (ζ₂) or a fourth stopping criterion (k=I₂) corresponding to the second maximum iteration number (I₂) is met;
if the third stopping criterion and the fourth stopping criterion are both not met, starting, by the analysis model, next secondary optimization iteration; and
if the third stopping criterion or the fourth stopping criterion is met,
ending, by the analysis model, the performed secondary optimization iteration without starting next secondary optimization iteration; and
outputting, by the analysis model, the recovered complete matrix (M) according to the latest further first matrix (U^{k}), the latest further second matrix (V^{k}), and outputting a sparse matrix (S) by the latest sparse matrix (S^{k}).

3. The method of claim 2, wherein before performing the primary optimization iteration, the method further comprises:
initializing a second matrix (V⁰) by generating a standard Gaussian matrix and setting a sparse matrix (S) as 0; and
initializing k, indicates the number of the performed primary optimization iteration, as 1,
wherein the primary optimization iteration comprises:
step 1: calculating a new first matrix (U^{k}) according to a latest first matrix (U^{k-1}) and a latest second matrix (V^{k-1});
step 2: calculating a new second matrix (V^{k}) according to a latest second matrix (V^{k-1}) and a latest first matrix (U^{k}); and
step 3: calculating a relative error (rel_{E}) corresponding to the latest first matrix (U^{k}), the latest second matrix (V^{k}), the first values and the first indexes,
wherein if the first stopping criterion and the second stopping criterion are determined both not met, k is added by 1 and continuing to step 1 of the next primary optimization iteration.

4. The method of claim 3, wherein k, indicates the number of the performed secondary optimization iteration, is initialized as 1 before performing the secondary optimization iteration, and the secondary optimization iteration comprises following steps:
Step 1: calculating a first robustness parameter (c^{k}) and a second robustness parameter (σ^{k}) according to the preset first parameter (ξ₁)and the preset second parameter (ξ₂);
step 2: calculating the sparse matrix (S^{k}) according to a latest further first matrix (U^{k-1})and a latest further second matrix (V^{k-1});
step 3: calculating a new further first matrix (U^{k}) according to the latest further first matrix (U^{k-1}), the latest further second matrix (V^{k-1}), the first values, the first indexes and the sparse matrix (S^{k});
step 4: calculating a new further second matrix (V^{k}) according to the latest further second matrix (V^{k-1}), the latest further first matrix (U^{k}), the first values, the first indexes and the sparse matrix (S^{k}); and
step 5: calculating a further relative error (rel_{E}) corresponding to the latest further first matrix (U^{k}), the latest further second matrix (V^{k}), the first values and the first indexes,
wherein if the third stopping criterion and the fourth stopping criterion are determined both not met, k is added by 1 and continuing to step 1 of the next secondary optimization iteration.

5. The method of claim 4, wherein the method further comprising:
if the relative error (rel_{E}) is smaller or equal to the first tolerance parameter (ζ₁), determining that the first stopping criterion is met;
if the k is equal to the first maximum iteration number (I₁), determining that the second stopping criterion is met;
if the further relative error (rel_{E}) is smaller or equal to the second tolerance parameter (ζ₂), determining that the third stopping criterion is met;
if the k is equal to the second maximum iteration number (I₂), determining that the fourth stopping criterion is met.

6. The method of claim 1, wherein the first matrix or the further first matrix is calculated by an equation related to the HOW algorithm below:
U^{k+1}=U^{k}−\tilde{μ}_{U}^{k}\tilde{∇}h_{V}_{^{k}}(U^{k})
wherein \tilde{μ}_{U}^{k} denotes a step size corresponding to the first matrix or the further first matrix; and \tilde{∇}h_{V}_{^{k}}(·) denotes a gradient descent direction function corresponding to the first matrix or the further first matrix,
wherein the second matrix or the further second matrix is calculated by an equation related to the HOW algorithm below:
V^{k+1}=V^{k}−\tilde{μ}_{V}^{k}\tilde{∇}h_{U}_{^{k}}(V^{k})
wherein \tilde{μ}_{V}^{k} denotes a step size corresponding to the first matrix or the further first matrix; and \tilde{∇}h_{U}_{^{k}}(·) denotes a gradient descent direction function corresponding to the first matrix or the further first matrix.

7. The method of claim 1, wherein the recovered complete matrix (M) is calculated by an equation below:
M=U^{k}V^{k}
wherein U^{k} denotes the latest further first matrix obtained from the secondary optimization iterations; and V^{k} denotes the latest further second matrix obtained from the secondary optimization iterations.

8. An electronic device for a robust low-rank matrix recovery using Hybrid Ordinary-Welsch Function (HOW), comprising:
a processor, configured to execute machine instructions to implement a computer-implemented method, the method comprising:
receiving, by a processor of the electronic device, object data, wherein the object data comprises an incomplete matrix, wherein the incomplete matrix is a low-rank matrix;
identifying, by the processor, a plurality of first values and a plurality of first indexes of a plurality of first entries of the incomplete matrix, and one or more second values and one or more second indexes of one or more second entries of the incomplete matrix according to the object data,
wherein the first values of the first entries are determined as original values of the first entries, and the one or more second values of the second entries are determined as non-original values of the second entries;
inputting, by the processor, the first values (X_{Ω}), the first indexes(Ω), a rank r, the second indexes, a preset first parameter (ξ1), a preset second parameter (ξ2), a first maximum iteration number (I₁), a second maximum iteration number (I₂), a first tolerance parameter (ζ₁) and a second tolerance parameter (ζ₂) into an executed analysis model using HOW algorithm; and
obtaining, by the processor, a recovered complete matrix corresponding to the incomplete matrix from the analysis model, so as to obtain optimized one or more second values of the second entries, wherein the optimized one or more second values are determined as original values of the second entries, such that missing data corresponding to the second entries of the incomplete matrix is recovered by the recovered complete matrix.

9. The electronic device of claim 8, wherein the method further comprises:
starting, by the analysis model, a new primary optimization iteration to obtain a first matrix (U^{k}) and a second matrix (V^{k}) according to the first values and the first indexes;
determining, by the analysis model, whether a first stopping criterion (rel_{E}≤ζ₁) corresponding to the first tolerance parameter (ζ₁) or a second stopping criterion (k=I₁) corresponding to the first maximum iteration number (I₁) is met;
if the first stopping criterion and the second stopping criterion are both not met, starting, by the analysis model, next primary optimization iteration; and
if the first stopping criterion or the second stopping criterion is met,
ending, by the analysis model, the performed primary optimization iteration without starting next primary optimization iteration;
initializing, by the analysis model, a further first matrix (U⁰) by latest first matrix (U^{k}) obtained from the latest primary optimization iteration, and initializing a further second matrix (V⁰) by latest second matrix (V^{k}) obtained from the latest primary optimization iteration; and
starting, by the analysis model, a new secondary optimization iteration to obtain a further first matrix (U^{k}), a further second matrix (V^{k}), a sparse matrix (S^{k}), a first robustness parameter (c^{k}) and a second robustness parameter (σ^{k}) according to the first values, the first indexes, the initialized further first matrix (U⁰), the initialized further second matrix (V⁰), the first parameter (ξ₁), the second parameter (ξ₂);
determining, by the analysis model, whether a third stopping criterion (rel_{E}≤ζ₂) corresponding to the second tolerance parameter (ζ₂) or a fourth stopping criterion (k=I₂) corresponding to the second maximum iteration number (I₂) is met;
if the third stopping criterion and the fourth stopping criterion are both not met, starting, by the analysis model, next secondary optimization iteration; and
if the third stopping criterion or the fourth stopping criterion is met,
ending, by the analysis model, the performed secondary optimization iteration without starting next secondary optimization iteration; and
outputting, by the analysis model, the recovered complete matrix (M) according to the latest further first matrix (U^{k}), the latest further second matrix (V^{k}), and outputting a sparse matrix (S) by the latest sparse matrix (S^{k}).

10. The electronic device of claim 9, wherein before performing the primary optimization iteration, the method further comprises:
initializing a second matrix (V⁰) by generating a standard Gaussian matrix and setting a sparse matrix (S) as 0; and
initializing k, indicates the number of the performed primary optimization iteration, as 1,
wherein the primary optimization iteration comprises:
step 1: calculating a new first matrix (U^{k}) according to a latest first matrix (U^{k-1}) and a latest second matrix (V^{k-1});
step 2: calculating a new second matrix (V^{k}) according to a latest second matrix (V^{k-1}) and a latest first matrix (U^{k}); and
step 3: calculating a relative error (rel_{E}) corresponding to the latest first matrix (U^{k}), the latest second matrix (V^{k}), the first values and the first indexes,
wherein if the first stopping criterion and the second stopping criterion are determined both not met, k is added by 1 and continuing to step 1 of the next primary optimization iteration.

11. The electronic device of claim 10, wherein k, indicates the number of the performed secondary optimization iteration, is initialized as 1 before performing the secondary optimization iteration, and the secondary optimization iteration comprises following steps:
Step 1: calculating a first robustness parameter (c^{k}) and a second robustness parameter (σ^{k}) according to the preset first parameter (ξ₁)and the preset second parameter (ξ₂);
step 2: calculating the sparse matrix (S^{k}) according to a latest further first matrix (U^{k-1})and a latest further second matrix (V^{k-1});
step 3: calculating a new further first matrix (U^{k}) according to the latest further first matrix (U^{k-1}), the latest further second matrix (V^{k-1}), the first values, the first indexes and the sparse matrix (S^{k});
step 4: calculating a new further second matrix (V^{k}) according to the latest further second matrix (V^{k-1}), the latest further first matrix (U^{k}),, the first values, the first indexes and the sparse matrix (S^{k}); and
step 5: calculating a further relative error (rel_{E}) corresponding to the latest further first matrix (U^{k}), the latest further second matrix (V^{k}), the first values and the first indexes,
wherein if the third stopping criterion and the fourth stopping criterion are determined both not met, k is added by 1 and continuing to step 1 of the next secondary optimization iteration.

12. The electronic device of claim 11, wherein the method further comprising:
if the relative error (rel_{E}) is smaller or equal to the first tolerance parameter (ζ₁), determining that the first stopping criterion is met;
if the k is equal to the first maximum iteration number (I₁), determining that the second stopping criterion is met;
if the further relative error (rel_{E}) is smaller or equal to the second tolerance parameter (ζ₂), determining that the third stopping criterion is met;
if the k is equal to the second maximum iteration number (I₂), determining that the fourth stopping criterion is met.

13. The electronic device of claim 8, wherein the first matrix (U^{k}) or the further first matrix is calculated by an equation related to the HOW algorithm below:
U^{k+1}=U^{k}−\tilde{μ}_{U}^{k}\tilde{∇}h_{V}_{^{k}}(U^{k})
wherein \tilde{μ}_{U}^{k} denotes a step size corresponding to the first matrix or the further first matrix; and \tilde{∇}h_{V}_{^{k}}(·) denotes a gradient descent direction function corresponding to the first matrix or the further first matrix,
wherein the second matrix (V^{k}) or the further second matrix is calculated by an equation related to the HOW algorithm below:
V^{k+1}=V^{k}−\tilde{μ}_{V}^{k}\tilde{∇}h_{U}_{^{k}}(V^{k})
wherein \tilde{μ}_{V}^{k} denotes a step size corresponding to the first matrix or the further first matrix; and \tilde{∇}h_{U}_{^{k}}(·) denotes a gradient descent direction function corresponding to the first matrix or the further first matrix.

14. The electronic device of claim 8, wherein the recovered complete matrix (M) is calculated by an equation below:
M=U^{k}V^{K}
wherein U^{k} denotes the latest further first matrix obtained from the secondary optimization iterations; and V^{k} denotes the latest further second matrix obtained from the secondary optimization iterations.
